(19) United States
(12) Patent Application Publication
(10) Pub. No.: US 2026/0077664 A1
(43) Pub. Date: Mar. 19, 2026

(54) ELECTRIFIED VEHICLE

(71) Applicants: TOYOTA JIDOSHA KABUSHIKI KAISHA, Toyota-shi (JP); SUBARU CORPORATION, Tokyo (JP)

(72) Inventor: Ryosuke ASA, Nagakute-shi (JP)

(73) Assignees: TOYOTA JIDOSHA KABUSHIKI KAISHA, Toyota-shi (JP); SUBARU CORPORATION, Tokyo (JP)

(21) Appl. No.: 19/324,521

(22) Filed: Sep. 10, 2025

(30) Foreign Application Priority Data
Sep. 17, 2024 (JP) 2024-159806

(51) Int. Cl. B60L 53/16; B60L 50/60

(52) U.S. Cl. CPC B60L 53/16; B60L 50/60

(57) ABSTRACT

An electrified vehicle includes a body framework, a battery, and a fender panel having an outer side surface and an inner side surface. An opening passing from the outer side surface to the inner side surface and housing a lid panel is provided on the fender panel. The electrified vehicle further includes a bracket fixed to the periphery of the opening on the inner side surface, a lid box having the lid panel attached and fixed to the bracket, a charging inlet supplying external electric power to the battery by insertion of an external electric power source connector and fixed to the lid box at a position that is more distant from the lid panel than the lid box is, and a reinforcement member connected to the bracket and the body framework and fixing the bracket to the body framework.

### CROSS-REFERENCE TO RELATED APPLICATION

This application claims priority to Japanese Patent Application No. 2024-159806 filed on September 17, 2024. The disclosure of the above-identified application, including the specification, drawings, and claims, is incorporated by reference herein in its entirety.

### BACKGROUND

### 1. Technical Field

The present disclosure relates to an electrified vehicle.

### 2. Description of Related Art

[ 0003 ] Conventionally, an electrified vehicle such as a battery electric vehicle and a hybrid electric vehicle is known. The electrified vehicle travels by driving an electric motor using the electric power stored in a battery. The battery is charged by the electric power that is supplied from an external electric power source (for example, a household electric power source or a charging station). For example, as shown in Japanese Unexamined Patent Application Publication No. 2016-107680 (JP 2016-107680 A), the charging is performed by connecting an external charging connector connected to the external electric power source, to a charging inlet of the electrified vehicle.

### SUMMARY

A lid box that functions as a cover (specifically, a semi-outer plate design component) of the charging inlet is attached to the charging inlet, and in this state, the lid box is attached to a bracket provided on the inner side of a fender panel. Thereby, the lid box and the charging inlet can be fixed to the fender panel. However, in this case, there is a concern that the fender panel may deform when the external charging connector is strongly inserted into the charging inlet or when a great force is applied to the external charging connector in any of upward, downward, rightward, and leftward directions.

The present disclosure provides an electrified vehicle that makes it possible to restrain the deformation of the fender panel at the time of the charging from the external electric power source, even in the case of the configuration in which the lid box and the charging inlet are fixed to the fender panel through the bracket.

An electrified vehicle in the present disclosure includes a body framework, a battery, and a fender panel having an outer side surface that is exposed to the exterior and an inner side surface that is a back surface of the outer side surface. An opening is provided on the fender panel, the opening passing from the outer side surface to the inner side surface and housing a lid panel. The electrified vehicle further includes a bracket that is fixed to the periphery of the opening on the inner side surface, a lid box to which the lid panel is attached and that is fixed to the bracket, a charging inlet that supplies external electric power to the battery by insertion of an external electric power source connector and that is fixed to the lid box at a position that is more distant from the lid panel than the lid box is, and a reinforcement member that is connected to the bracket and the body framework and that fixes the bracket to the body framework.

In this configuration, even in the case where a force that causes the deformation of the fender panel is applied to the fender panel by the external electric power source connector when the external electric power source connector is inserted into or removed from the charging inlet, the reinforcement member makes it possible to restrain the fender panel from deforming.

The charging inlet may include a base portion on the lid box side and a distal end portion on the opposite side of the base portion. The charging inlet may be fixed to the lid box in a state where the charging inlet is inclined such that the distal end portion is oriented obliquely downward.

In this configuration, a person that performs charging operation to the electrified vehicle can easily insert the external electric power source connector into the charging inlet.

The reinforcement member may extend in a front-rear direction of the electrified vehicle, and may be connected to each of the bracket and the body framework at a plurality of spots.

In this configuration, it is possible to further restrain the deformation of the fender panel when the force that causes the deformation of the fender panel is applied by the external electric power source connector at the time of the charging, compared to a case where the reinforcement member is connected to each of the bracket and the body framework at one spot.

The reinforcement member may be a metal fitting in which a transverse section has an L-shape, and may include a bottom portion that is parallel to a horizontal plane and a side portion that extends from the bottom portion vertically upward. The bottom portion may be fastened to the bracket by a first bolt that penetrates the bottom portion in a vertical direction. The side portion may be fastened to the body framework by a second bolt that penetrates the side portion in a horizontal direction.

In this configuration, the strength of the reinforcement member is achieved by a lightweight and simple configuration. Furthermore, at the time of the production of the electrified vehicle, a work to tighten the first and second bolts in a state where the first and second bolts are inserted in an oblique direction is not required. Accordingly, with the reinforcement member, the workability when the reinforcement member is attached to the bracket and the body framework is enhanced.

The present disclosure makes it possible to restrain the deformation of the fender panel at the time of the charging from the external electric power source, even in the case of the electrified vehicle having the configuration in which the lid box and the charging inlet are fixed to the fender panel through the bracket.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of the electrified vehicle 1;

FIG. 2 is a perspective view showing an external appearance of the vicinity of an opening;

FIG. 3 is a perspective view showing the interior of a vehicle at the vicinity of the opening;

FIG. 4 is a diagram for describing a method for fixing a charging inlet to a lid box and a method for fixing the lid box to a bracket;

FIG. 5 is a sectional view taken from line V-V in FIG. 4 and viewed along arrows of line V-V; and

FIG. 6 is a sectional view taken from line VI-VI in FIG. 4 and viewed along arrows of line VI-VI.

### DETAILED DESCRIPTION OF EMBODIMENTS

An embodiment of the present disclosure will be described below with reference to the drawings. In the following description, identical members are denoted by identical reference characters. The names and functions of the identical members are the same. Accordingly, detailed descriptions about the identical members are not repeated.

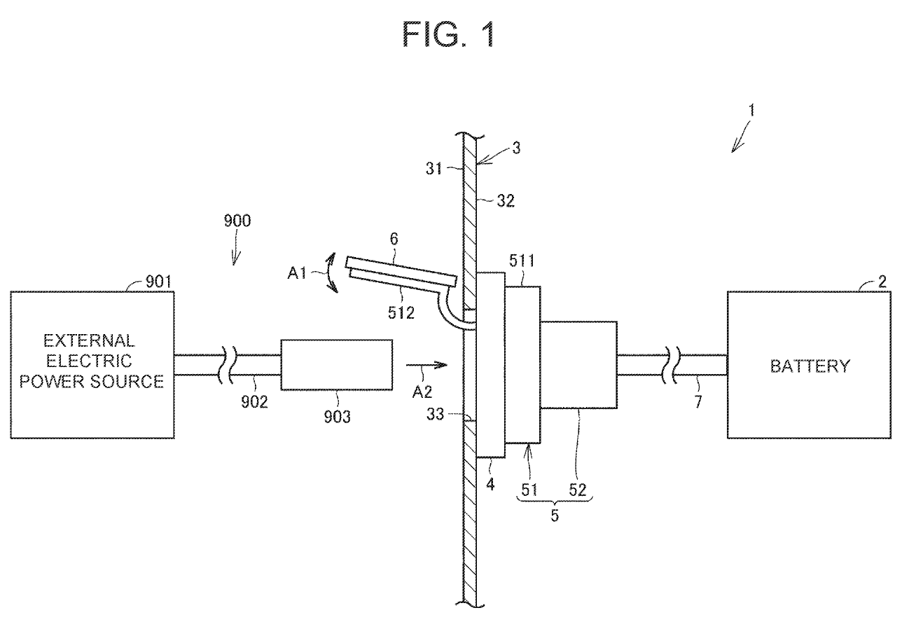

FIG. 1 is a diagram showing a schematic configuration of an electrified vehicle 1 in the embodiment. FIG. 1 shows a state immediately before the electrified vehicle 1 is charged. The electrified vehicle 1 is a hybrid electric vehicle that can travel using the dynamic power of at least one of a motor and an engine, or a battery electric vehicle that travels using the drive power obtained by electric energy.

As shown in FIG. 1, the electrified vehicle 1 includes a battery 2, a fender panel 3, a bracket 4, a charging connector 5, a lid panel 6, and a cable 7. The charging connector 5 includes a lid box 51 and a charging inlet 52. The lid box 51 includes a main body portion 511 and a movable portion 512 that can move with respect to the main body portion 511. A configuration including the lid panel 6 and the lid box 51 is also referred to as a "charging lid".

The fender panel 3 has an outer side surface 31 that is exposed to the exterior and an inner side surface 32 that is a back surface of the outer side surface 31. An opening 33 that passes from the outer side surface 31 to the inner side surface 32 and that houses the lid panel 6 is formed on the fender panel 3. In the example, the opening 33 is formed near a right front wheel. Without being limited to this, the opening 33 is formed near a left front wheel, depending on country's specification. The opening 33 is an opening for the charging lid, and is also referred to as a "charging port".

An electricity device 900 includes an external electric power source 901, a cable 902, and an external electric power source connector 903. The external electric power source connector 903 is also referred to as a "charging gun" or "charging link". The external electric power source connector 903 is connected to the external electric power source 901 through the cable 902.

The bracket 4 is attached to the inner side surface 32 of the fender panel 3. Specifically, the bracket 4 is fixed to the periphery of the opening 33 on the inner side surface 32. The bracket 4 is fixed to the inner side surface 32 of the fender panel 3, by machine fastening such as welding and bolt fastening.

The lid box 51 plays a role as an opening-closing mechanism for the lid panel 6 and a role as a cover (semi-outer plate design component) for the charging inlet 52. The lid box 51 makes it possible to prevent the charging inlet 52 from being in a bare state at the vicinity of the opening 33.

Specifically, the lid box 51 is fixed to the bracket 4. The lid panel 6 is attached to the lid box 51. Specifically, the main body portion 511 of the lid box 51 is fixed to the bracket 4. The main body portion 511 is positioned on the vehicle inner side of the electrified vehicle 1. The movable portion 512 of the lid box 51 is attached to the main body portion 511 by a hinge (not illustrated) as the opening-closing mechanism. The lid panel 6 is attached to the movable portion 512. The movable portion 512 can move in the direction of an arrow A1 together with the lid panel 6.

In a state where the lid panel 6 is closed, the lid panel 6 is housed in the opening 33 of the fender panel 3. When the lid panel 6 is closed, the opening 33 is covered. The movable portion 512 is housed on the vehicle inner side of the lid panel 6.

The charging inlet 52 is fixed to the lid box 51 at a position that is more distant from the lid panel 6 than the lid box 51 is. Consequently, the lid box 51 and the charging inlet 52 are fixed to the fender panel 3 through the bracket 4. The charging inlet 52 is positioned on the vehicle inner side of the lid box 51. The charging inlet 52 supplies, to the battery 2, the electric power that is supplied from the external electric power source 901 through the external electric power source connector 903. Specifically, the charging inlet 52 supplies the electric power of the external electric power source 901 to the battery 2 through the cable 7. The cable 7 is connected to the battery 2 and the charging inlet 52.

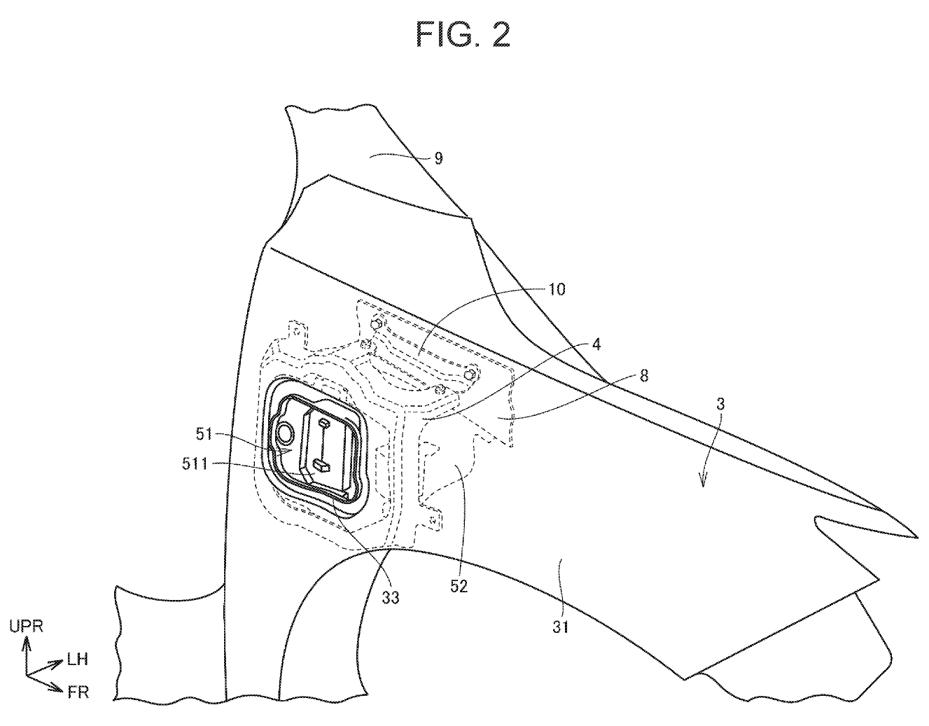

In the case where the electrified vehicle 1 is in accordance with a specification for North America, the charging inlet 52 includes a common inlet (see FIG. 2) that serves as an inlet for alternating-current charging and an inlet for direct-current charging. In the case where the electrified vehicle 1 is in accordance with a specification for Europe, China, Japan, or the like, the charging inlet 52 includes the inlet for alternating-current charging and the inlet for direct-current charging separately. In the specification for Europe, the inlet for alternating-current charging and the inlet for direct-current charging are disposed so as to be arrayed in a top-bottom direction (vertical direction). In the specification for China and the specification for Japan, the inlet for alternating-current charging and the inlet for direct-current charging are disposed so as to be arrayed in a lateral direction (horizontal direction).

At the time of the production of the electrified vehicle 1, the charging inlet 52 is attached to the electrified vehicle 1, by the following process. The following process is executed by a worker or an assembling robot for working (also referred to as a "worker or the like", hereinafter). The worker or the like fixes the lid box 51 and the charging inlet 52 to each other by bolts or the like, in advance. Thereby, an assembly (specifically, the charging connector 5) including the lid box 51 and the charging inlet 52 is formed. Next, the worker or the like fixes the bracket 4 to the inner side surface 32 of the fender panel 3 by the above-described machine fastening. Furthermore, the worker or the like fixes the lid box 51 to the bracket 4 from the vehicle inner side, by bolts or the like. By the fixation, the charging inlet 52 is positionally fixed to the fender panel 3, together with the lid box 51. In this way, the charging connector 5 is fixed to the bracket 4 attached to the inner side surface 32 of the fender panel 3, from the inner side of the electrified vehicle 1. Thus, the charging inlet 52 is attached to the electrified vehicle 1.

A person (for example, the driver of the electrified vehicle 1 or a service man of a shop) that performs the charging operation of the electrified vehicle 1 moves the external electric power source connector 903 in the direction of the opening 33 (in the direction of an arrow A2), in a state where the lid panel 6 is opened as shown in FIG. 1, and inserts the external electric power source connector 903 into the charging inlet 52. Thereafter, the person that performs the charging operation selects a charging start button, and thereby, the charging of the battery 2 from the external electric power source 901 is started.

FIG. 2 is a perspective view showing an external appearance of the vicinity of the opening 33. For explanatory convenience, in FIG. 2, the lid panel 6 and the movable portion 512 of the lid box 51 are not illustrated.

As shown in FIG. 2, the electrified vehicle 1 further includes a body framework 8, an A-pillar 9, and a reinforcement member 10, in addition to the fender panel 3, the bracket 4, the lid box 51, and the charging inlet 52. The opening 33 is formed below a lower end portion of the A-pillar 9. The body framework 8 is positioned in the interior of the electrified vehicle 1. UPR in the figure indicates the vertically upward direction. FR indicates the orientation of the front of the electrified vehicle 1. LH indicates the left direction viewed from a driver that sits in a seat.

As described above, the charging inlet 52 is positioned on the inner side of the lid box 51 in the vehicle. In the example, the lid box 51 and the charging inlet 52 are positioned below the A-pillar 9 and above the front wheel (not illustrated).

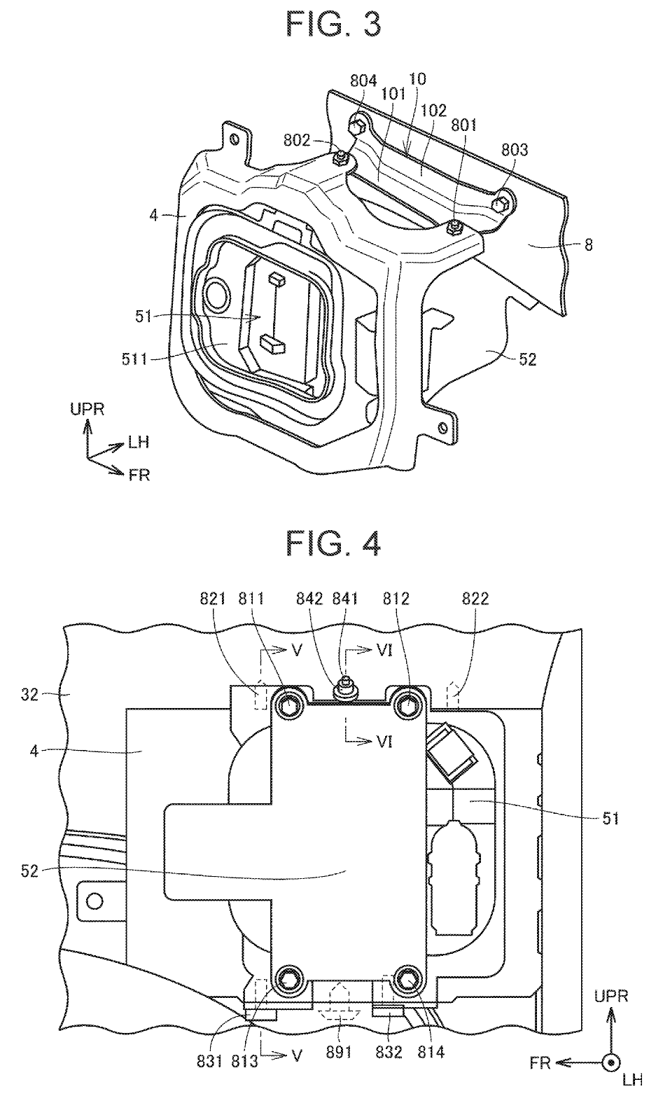

FIG. 3 is a perspective view showing the interior of the vehicle at the vicinity of the opening 33. As shown in FIG. 3, the reinforcement member 10 is connected to the bracket 4 and the body framework 8, and fixes the bracket 4 to the body framework 8. The reinforcement member 10 fixes the bracket 4 holding the charging inlet 52 and the lid box 51, to the body framework 8. The reinforcement member 10 plays a role as a bridge between the bracket 4 and the body framework 8.

Specifically, the reinforcement member 10 is connected to an upper end portion of the bracket 4. The reinforcement member 10 extends in a front-rear direction of the electrified vehicle 1. The reinforcement member 10 is connected to each of the bracket 4 and the body framework 8 at a plurality of spots. In the example, the reinforcement member 10 is connected to the bracket 4 at two spots, and is connected to the body framework 8 at two spots. Specifically, the reinforcement member 10 is fixed to the bracket 4 by two bolts 801, 802. The reinforcement member 10 is fixed to the body framework 8 by two bolts 803, 804.

More specifically, in the example, the reinforcement member 10 is a metal fitting in which a transverse section has an L-shape. The reinforcement member 10 includes a bottom portion 101 that is parallel to a horizontal plane and a side portion 102 that extends from the bottom portion 101 vertically upward. The bottom portion 101 is fastened to the bracket 4 by the bolts 801, 802. The side portion 102 is fastened to the body framework 8 by the bolts 803, 804. The bolts 801, 802 penetrate the bottom portion 101 in a vertical direction. The bolts 803, 804 penetrate the side portion 102 in a horizontal direction. The transverse section of the reinforcement member 10 is not limited to the L-shape.

At the time of the production of the electrified vehicle 1, the reinforcement member 10 is fixed to the bracket 4 and the body framework 8, before the charging connector 5 is attached to the bracket 4.

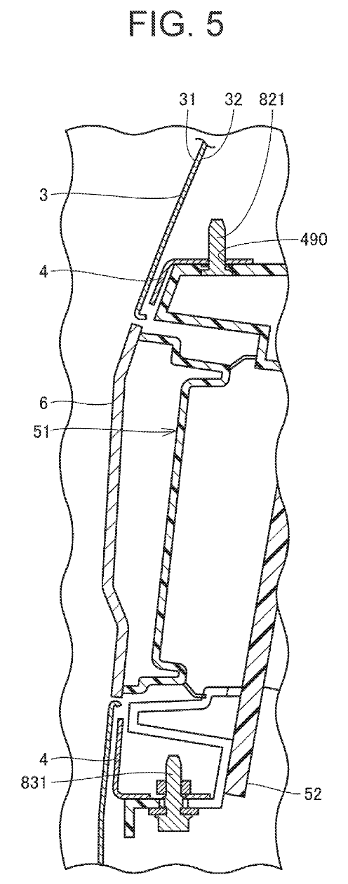

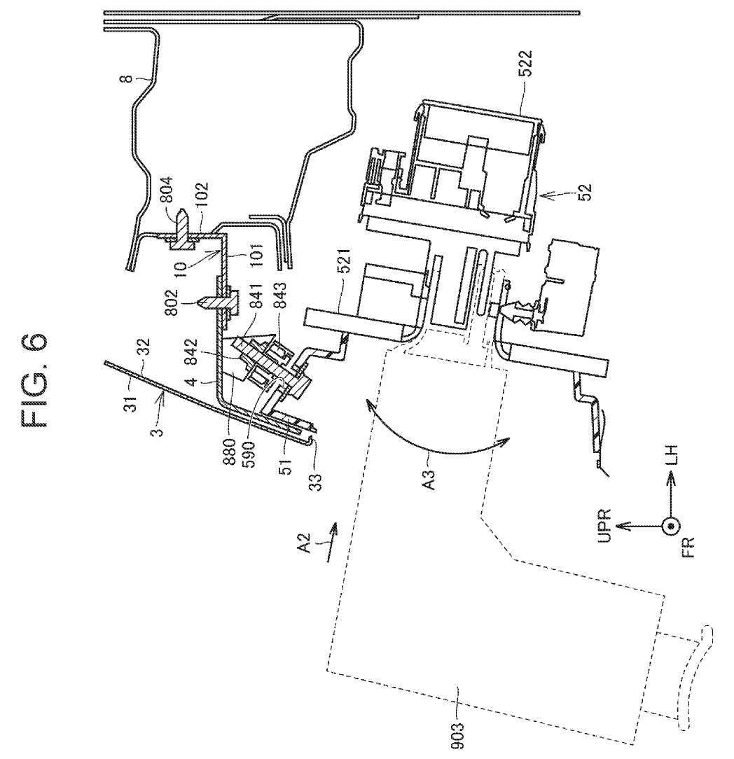

FIG. 4 is a diagram for describing a method for fixing the charging inlet 52 to the lid box 51 and a method for fixing the lid box 51 to the bracket 4. FIG. 4 is a diagram when the bracket 4 side is viewed from the charging inlet 52 side. That is, FIG. 4 is a diagram when the vehicle outer side is viewed from the vehicle inner side. FIG. 5 is a sectional view taken from line V-V in FIG. 4 and viewed along arrows of line V-V. FIG. 6 is a sectional view taken from line VI-VI in FIG. 4 and viewed along arrows of line VI-VI.

As shown in FIG. 4, the charging inlet 52 is previously fixed to the lid box 51 by a plurality of bolts 811, 812, 813, 814. As shown in FIG. 4 and FIG. 5, the lid box 51 includes a plurality of metal pins 821, 822. The metal pins 821, 822 extend vertically upward. The metal pins 821, 822 project upward from an upper end surface of the lid box 51.

When the lid box 51 is attached to the bracket 4, the worker or the like inserts the metal pins 821, 822 into through-holes 490 (FIG. 5) of the bracket 4 from the lower side, as shown in FIG. 4 and FIG. 5. Next, as shown in FIG. 4, the worker or the like temporarily fixes a lower end of the lid box 51 to the bracket 4 by a clip 891.

Next, as shown in FIG. 4 and FIG. 5, the worker or the like fixes the lower end portion of the lid box 51 to the bracket 4 by a plurality of bolts 831, 832. Thereafter, the worker or the like detaches the clip 891 from the lid box 51.

Finally, the worker or the like attaches an upper end portion of the lid box 51 to the bracket 4, by a bolt 841, a weld nut 842, and an adjustable nut 843 (FIG. 6) that allows the adjustment of a gap. Specifically, the adjustable nut 843 is previously fixed to a bracket 880 (FIG. 6) fixed to the bracket 4 by welding.

More specifically, as shown in FIG. 6, the worker or the like inserts a bolt 841 into a through-hole 590 formed on the upper end portion of the lid box 51, and tightens the bolt 841. When the bolt 841 is tightened, the adjustable nut 843 expands in an extension direction (axis direction) of an under-head portion of the bolt 841. When the adjustable nut 843 makes contact with the lid box 51, an adjustment work ends.

An example in which the lower end portion of the lid box 51 is fixed to the bracket 4 by the two bolts 831, 832 has been described above, but the number of bolts is not limited to two. The lid box 51 only needs to be fixed to the bracket 4 by at least one bolt.

Furthermore, as shown in FIG. 6, the charging inlet 52 includes a base portion 521 on the lid box side and a distal end portion 522 on the opposite side of the base portion 521. The charging inlet 52 is fixed to the lid box 51 in a state where the charging inlet 52 is inclined such that the distal end portion 522 is oriented obliquely downward. The cable 7 (FIG. 1) is attached to the distal end portion 522.

### Advantages

The electrified vehicle 1 having the above configuration has the following advantages.

(1) In the case where the person that performs the charging operation pushes the external electric power source connector 903 inserted into the charging inlet 52, for example, in the direction of the charging inlet 52 (in the direction of an arrow A2 in FIG. 6) with a great force, the above force applied to the charging inlet 52 is transmitted to the bracket 4 through the lid box 51. The bracket 4 is fixed to the fender panel 3 by welding or the like, and therefore, the above force is transmitted to the fender panel 3. Therefore, a force that causes the deformation of the fender panel 3 is applied to the fender panel 3. The force that causes the deformation of the fender panel 3 acts on the fender panel 3 similarly even in the case where the external electric power source connector 903 is moved in the vertical direction (in the direction of an arrow A3 in FIG. 6) with a great force or in the case where the external electric power source connector 903 is moved in the horizontal direction with a great force.

In response, the electrified vehicle 1 includes the reinforcement member 10 that is connected to the bracket 4 and the body framework 8 and that fixes the bracket 4 to the body framework 8. Accordingly, even in the case where the force that causes the deformation of the fender panel 3 is applied to the fender panel 3 by the external electric power source connector 903 when the external electric power source connector 903 is inserted into or removed from the charging inlet 52, the reinforcement member 10 makes it possible to restrain the fender panel 3 from deforming. Specifically, the reinforcement member 10 makes it possible to restrain the stiffness deformation (that is, deflection) or plastic deformation of the fender panel 3.

(2) In the configuration of the electrified vehicle 1, the lid box 51 and the charging inlet 52 are attached to the bracket 4 attached to the inner side surface 32 of the fender panel 3, from the inner side of the electrified vehicle 1. Therefore, it is possible to reduce the size of the opening 33 compared to a configuration in which the lid box 51 and the charging inlet 52 are attached from the outer side of the electrified vehicle 1. Consequently, it is possible to increase the flexibility of the design of the electrified vehicle 1, and to increase the size of a tire.

(3) As described above, the charging inlet 52 is fixed to the lid box 51 in the state where the charging inlet 52 is inclined such that the distal end portion 522 is oriented obliquely downward. Therefore, the person that performs the charging operation can easily insert the external electric power source connector 903 into the charging inlet 52.

(4) As described above, the reinforcement member 10 extends in the front-rear direction of the electrified vehicle. The reinforcement member 10 is connected to each of the bracket 4 and the body framework 8 at a plurality of spots. Accordingly, it is possible to further restrain the deformation of the fender panel 3 when the force that causes the deformation of the fender panel 3 is applied by the external electric power source connector 903 at the time of the charging, compared to a case where the reinforcement member 10 is connected to each of the bracket 4 and the body framework 8 at one spot.

(5) The reinforcement member 10 is the metal fitting in which the transverse section has an L-shape, and therefore, the strength is achieved by a lightweight and simple configuration. The bottom portion 101 of the reinforcement member 10 is fastened to the bracket 4 by the bolts 801, 802 that penetrate the bottom portion 101 in the vertical direction. The side portion 102 is fastened to the body framework 8 by the bolts 803, 804 that penetrate the side portion 102 in the horizontal direction. The bottom portion 101 is parallel to the horizontal plane, and the side portion 102 extends from the bottom portion 101 vertically upward.

Therefore, at the time of the production of the electrified vehicle 1, a work to tighten the bolts 801 to 804 in a state where the bolts 801 to 804 are inserted in an oblique direction is not required. Accordingly, with the reinforcement member 10, the workability when the reinforcement member 10 is attached to the bracket 4 and the body framework 8 is enhanced.

(6) In the electrified vehicle 1, the charging inlet 52 is fixed to the fender panel 3 through the lid box 51 and the bracket 4. The charging inlet 52 is not fixed to the body framework 8 directly or by a bracket dedicated for the charging inlet.

Accordingly, in the case where a force is applied to the right surface side of the electrified vehicle 1 from the front side by a collision accident, it is possible to cause the charging inlet 52 to drop from the electrified vehicle 1 together with the fender panel 3. Therefore, it is possible to prevent the charging inlet 52 from being fixed to the body framework 8 in a state where the charging inlet 52 is collapsed. Specifically, it is possible to cause the charging inlet 52 to drop from the electrified vehicle 1, by considering the strength of the reinforcement member 10 and the attachment way of the reinforcement member 10 such that the reinforcement member 10 is fractured by the collision and the bracket 4 is released from the body framework 8.

### Modification

An example in which the reinforcement member 10 is one metal fitting has been described above, but the present disclosure is not limited to this. The reinforcement member 10 may be constituted by a plurality of metal fittings. In this case, from the standpoint of the enhancement of the strength of the reinforcement. it is preferable that extension directions of all metal fittings are not the same. For example, it is preferable that the reinforcement member 10 includes a metal fitting that extends in the horizontal direction as shown in FIG. 3 and a metal fitting that extends in the vertical direction. In this case, it is preferable that the metal fitting that extends in the vertical direction is provided, for example, at a left end portion or right end portion of the bracket 4 in the side view of the electrified vehicle 1. Furthermore, the metal fitting that extends in the horizontal direction may be provided, for example, at a lower end portion of the bracket 4 in the side view of the electrified vehicle 1.

It should be understood that the embodiments disclosed herein are examples and are not limitative in all respects. It is intended that the scope of the present disclosure is shown by the claims and includes all alterations within meanings and ranges equivalent to the claims.

What is claimed is:

1. An electrified vehicle comprising:
a body framework;
a battery; and
a fender panel having an outer side surface that is exposed to an exterior and an inner side surface that is a back surface of the outer side surface, wherein:
an opening is provided on the fender panel, the opening passing from the outer side surface to the inner side surface and housing a lid panel; and
the electrified vehicle further includes
a bracket that is fixed to a periphery of the opening on the inner side surface,
a lid box to which the lid panel is attached and that is fixed to the bracket,
a charging inlet that supplies external electric power to the battery by insertion of an external electric power source connector and that is fixed to the lid box at a position that is more distant from the lid panel than the lid box is, and
a reinforcement member that is connected to the bracket and the body framework and that fixes the bracket to the body framework.

2. The electrified vehicle according to claim 1, wherein:
the charging inlet includes a base portion on the lid box side and a distal end portion on an opposite side of the base portion; and
the charging inlet is fixed to the lid box in a state where the charging inlet is inclined such that the distal end portion is oriented obliquely downward.

3. The electrified vehicle according to claim 1, wherein the reinforcement member extends in a front-rear direction of the electrified vehicle, and is connected to each of the bracket and the body framework at a plurality of spots.

4. The electrified vehicle according to claim 3, wherein:
the reinforcement member is a metal fitting in which a transverse section has an L-shape, and includes a bottom portion that is parallel to a horizontal plane and a side portion that extends from the bottom portion vertically upward;
the bottom portion is fastened to the bracket by a first bolt that penetrates the bottom portion in a vertical direction; and
the side portion is fastened to the body framework by a second bolt that penetrates the side portion in a horizontal direction.
